(19) United States
(12) Patent Application Publication
(10) Pub. No.: US 2007/0137101 A1
(43) Pub. Date: Jun. 21, 2007

(54) Carrier for growing trays and assembly of at least one such carrier and a growing tray

(75) Inventor: Petrus Johannes van Heugten, Achterveld (NL)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Modiform B.V., Leusden (NL)

(21) Appl. No.: 10/555,281

(22) PCT Filed: Apr. 29, 2004
(86) PCT No.: PCT/NL04/00287

§ 371 Date: Feb. 2, 2007

(30) Foreign Application Priority Data
May 2, 2003 (NL) 102336

(51) Int. Cl. A01G 9/02

(52) U.S. Cl. 47/65.5

(57) ABSTRACT

A carrier for growing trays, comprising a series of legs and a supporting surface carried thereby, wherein: in said supporting surface, adjacent at least a number of and preferably each of the legs, an opening is provided, such that the carriers in a storage position are stackable in nested position, with a number of legs of one or more upper carriers reaching into at least a number of said openings of a lower carrier, and the supporting surface determines at least one outer contour, while the legs extend at least partly outside said outer contour, such that two carriers in a position of use are stackable, with the legs of an upper carrier resting on the legs of a lower carrier.

The invention relates to a carrier for growing trays. The invention moreover relates to a series of such carriers and an assembly of such carriers and associated trays.

For growing crop, such as seedlings, use is made of growing trays. Such growing trays, which will hereinafter be further referred to as trays, typically comprise rows and columns of growing cavities in which in a growth medium, such as soil, rock wool, oasis or the like, seeds and/or seedlings can be grown to a size suitable, for instance, for singulation by repotting or placement in the open ground. Such trays can be pressed from a natural material, such as peat, but are typically manufactured from plastic sheet material, for instance through vacuum forming.

For setting these trays up on a growing surface and for moving them, the trays are conventionally placed on or in carriers. However, the carriers known from practice have drawbacks.

It is known to use, as a carrier, a plastic crate provided with a bottom with an upstanding edge arranged around the bottom. On two opposed sides, the edge is provided with a grip projecting above the edge. The tray is placed within the upstanding edge on the closed bottom. Several of such carriers can be stacked onto each other by placing a bottom of an upper carrier on the grips of a lower carrier. This known carrier has as a drawback that the edge takes up relatively much space. As a result, when two such carriers are placed side by side, the carriers are spaced apart, so that costly space is lost. Moreover, these carriers have as a drawback that both in filled condition, that is, when a tray is accommodated in them, and in empty condition, the carriers can only be stacked by placing the bottom on the grips, so that much costly storage and transport space is lost during storage or transport of the empty carriers. A further disadvantage of this known carrier is that aeration of crop in the tray is rendered more difficult by the carrier.

In an alternative embodiment of this known carrier, the bottom has been replaced with a carrying edge on which the tray can be carried. However, that merely solves the aeration problem.

A further known carrier consists of a plastic frame, carried by a number of legs. The frame comprises a circumferential longitudinal edge having a number of stiffening and carrying ribs extending in the longitudinal direction and width direction. These ribs have series of cavities or openings at the top. A tray can be supported on the edge and the ribs, with a number of growing cavities resting in the cavities and/or openings in the ribs. The associated tray to be used has a relatively wide, closed edge which rests on the longitudinal edge of the carrier and on which the legs of an upper carrier can be supported for stacking the carriers. This known carrier has the same drawback as the carriers described earlier with regard to stackability, particularly during storage and transport, while moreover during use costly growing space is lost owing in particular to the closed edge of the trays.

It has previously been proposed to integrate carriers and trays, so that substantially the entire top surface of the integrated tray can be provided with growing cavities. These carriers are provided with legs that can support on supporting surfaces on the top of the integrated tray, which entails little loss of space. However, this integrated carrier/tray has the same drawback as regards storage and transport. They are then to be stacked with the legs on said supporting surfaces, so that much costly storage and transport space is lost. Moreover, for different crops to be grown, different sizes of growing cavities will have to be used, so that in each case other combined carriers/trays must be used, which is costly and requires much storage capacity. Moreover, these known trays will have to be cleaned thoroughly for each renewed use, which is costly and time consuming.

The object of the invention is to provide a carrier for growing trays, whereby at least a number of the above-mentioned drawbacks of the known carriers are avoided. To that end, a carrier according to the invention is characterized by the features according to claim 1.

With a carrier according to the present invention, the advantage is achieved that the carriers can be nested in a storage position, such that they take up relatively little space, while in a condition of use the carriers can be stacked onto each in that the legs of an upper carrier can rest on the legs of a lower carrier, so that space is obtained between supporting surfaces of carriers, for providing thereon growing trays with crop, at least allowing crop to grow therein.

It is then preferred that the outer contour of each supporting surface is substantially rectangular, so that optimum use can be made of the space both on the carrier and on a growing surface on which carriers are set up. It is then particularly preferred when a carrier according to the invention is further characterized by the features according to claim 2.

With a series of such carriers, a continuous row can be formed, whereby the outer contours of two juxtaposed carriers can virtually, or even wholly, abut against each other, with the legs of the respective carriers on the sides mentioned being at least partly situated under the outer contour of the other carrier. In this way, optimum use can be made of available growing surface.

It is further preferred that a carrier according to the invention is further characterized by the features according to claim 5.

In such an embodiment, at least three and preferably at least four carriers can be brought into a nested storage position, so that an advantageous, compact locking is obtained. The height of the legs and the supporting surfaces is then preferably selected such that a first series of nested carriers can be placed on a second series of nested carriers, such that the supporting surfaces are at least virtually overlie each other, with the legs of the topmost nested carrier of the upper series being supported on the legs of the topmost carrier of the lower series. Thus, a particularly stable, compact nesting is obtained.

The invention further relates to a series of carriers according to the invention, characterized by the features of claim 7.

Thus, the advantages of carriers according to the invention can be used in a particularly advantageous manner.

The invention furthermore relates to an assembly of a carrier according to the invention, at least a series of such carriers, and at least one growing tray, characterized by the features according to claim 8.

With such an assembly, maximum use will be made of the surface area of the or each supporting surface, so that in an optimum manner use can be made of the surface areas available for growing. Here, the possibility is maintained of stacking the carriers onto each other in the earlier-mentioned position of use, so that carriers with trays can be set up above each other and, for instance, can be transported, stored and the like in that way.

Adjacent the outer contour, there is preferably a distance between the edge of the tray and the upper edge of the carrier, so that air can flow between these.

When the carriers with trays according to the invention are set up next to each other, they preferably abut against each other.

Carriers according to the invention are preferably manufactured from plastic, so that they are properly cleanable, relatively strong and durable, simple to manufacture and relatively light. Preferably, they are manufactured by injection molding. The trays are preferably likewise manufactured from plastic, in particular through deformation of sheet material. Thus, for instance, a tray may be manufactured through vacuum forming. Naturally, different trays can be provided, with different numbers, shapes and dimensions of growing cavities, each with an outer contour that corresponds to the outer contour of the carrier. In this way, the same carrier can be used for different crops or phases in cultivation.

The invention further relates to a method for growing and transporting seedlings and the like, characterized by the features according to claim 13.

With such a method, the advantage is achieved that both during transport and storage of empty carriers and/or trays and during cultivation with such carriers and trays, optimum use can be made of available space and capacity, which is economically advantageous.

In the subclaims, further advantageous embodiments of the invention are set forth. To clarify the invention, embodiments of a carrier, assembly and method according to the invention will be further elucidated with reference to the drawing, in which:

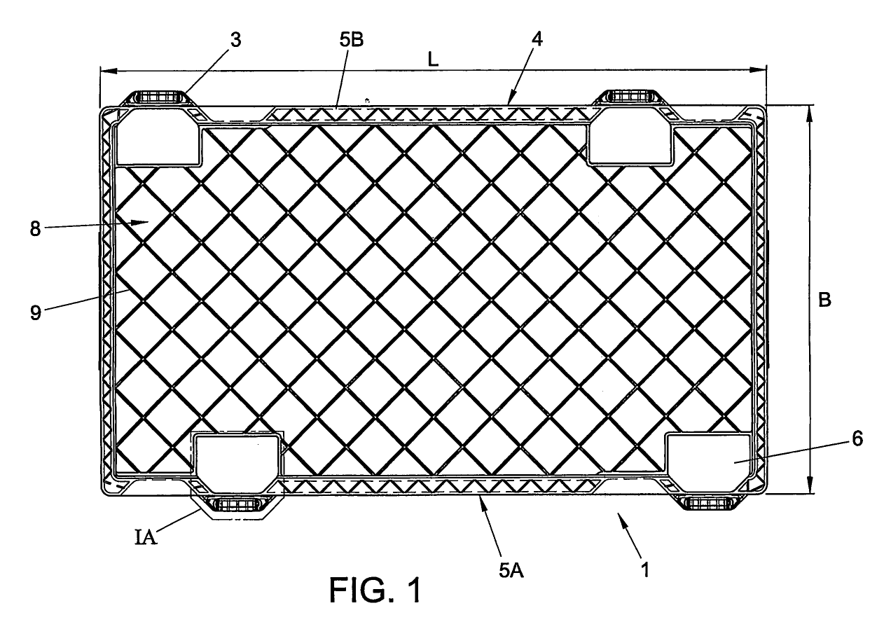

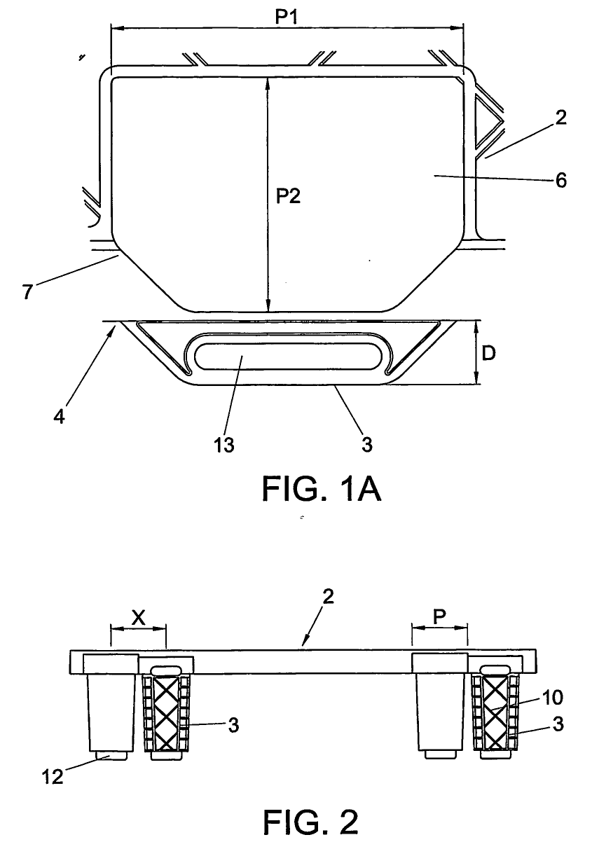

FIG. 1 shows a carrier according to the invention in bottom view;

FIG. 1A shows a detail of a carrier according to FIG. 1;

FIG. 2 shows a carrier according to FIG. 1 in side view;

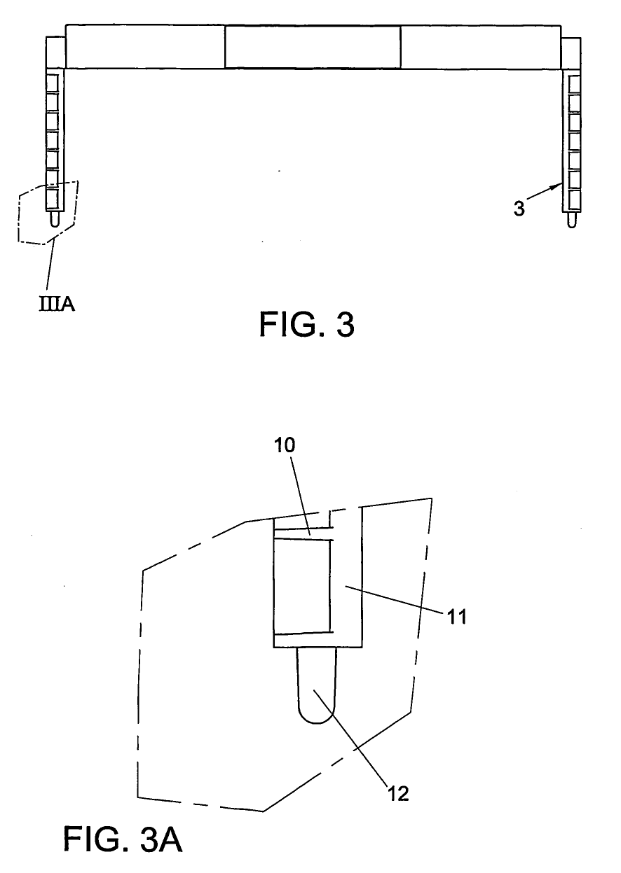

FIG. 3 shows the carrier according to FIG. 1 in front view;

FIG. 3A shows a detail of a lower end of a leg of a carrier according to FIG. 1;

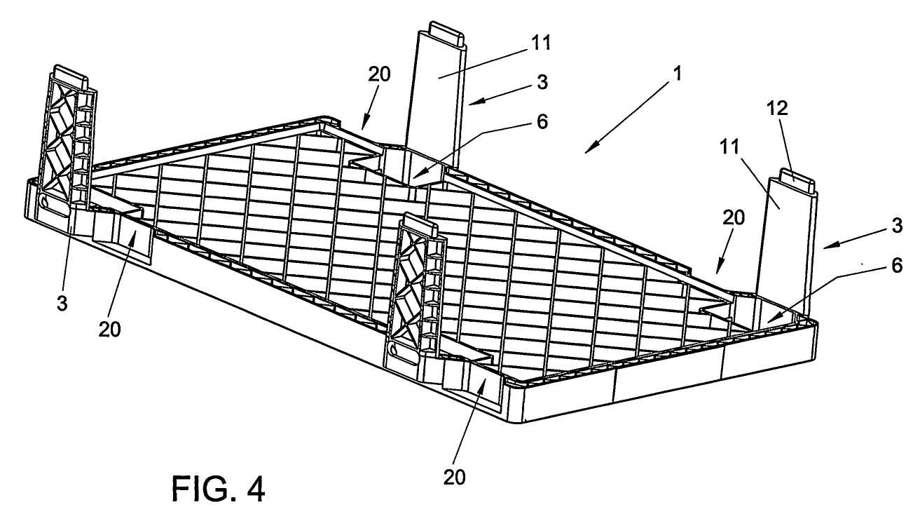

FIG. 4 shows a carrier according to FIG. 1 in perspective bottom view;

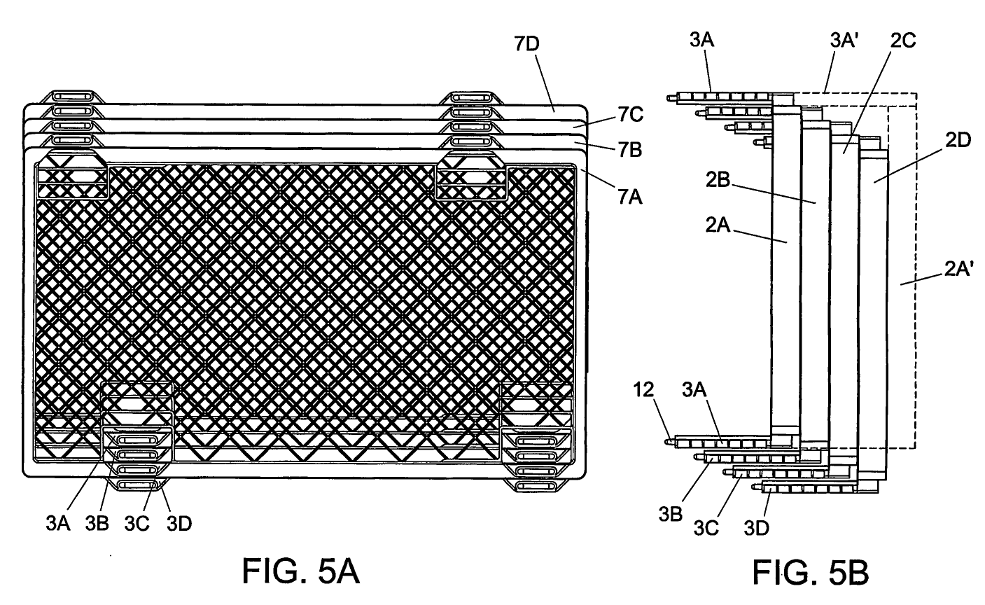

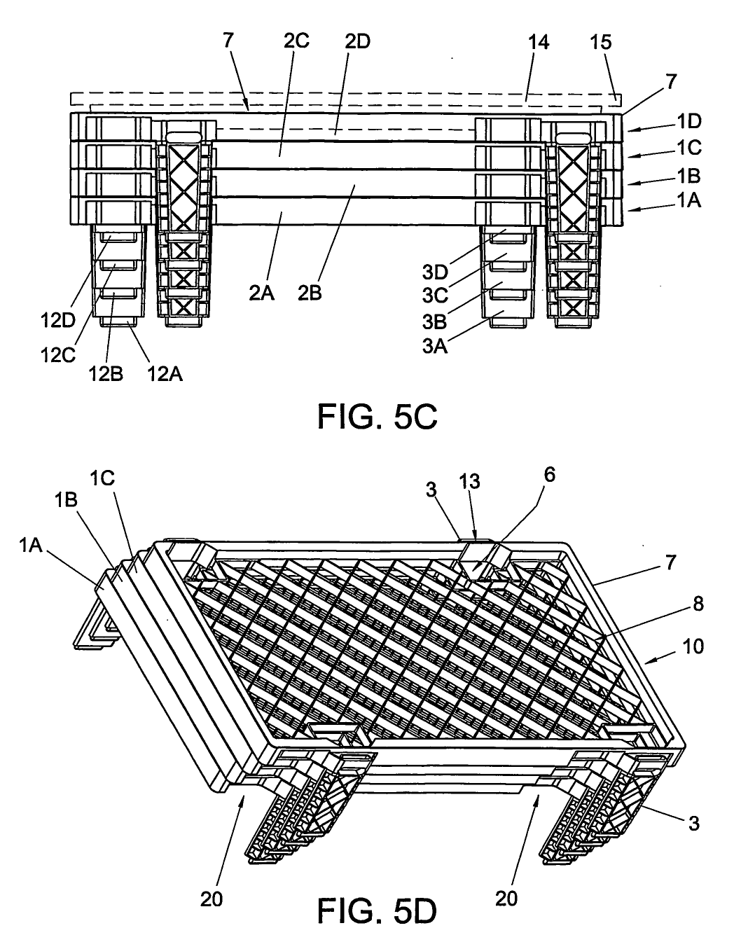

FIGS. 5A-D show a series of carriers according to FIG. 1 in nested condition, in different views;

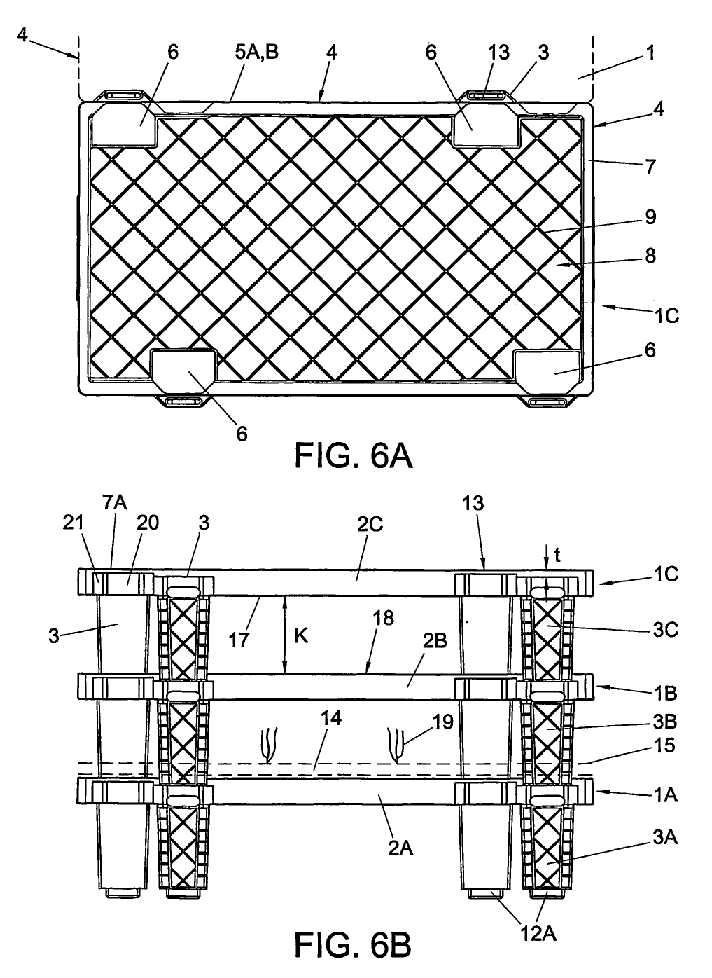

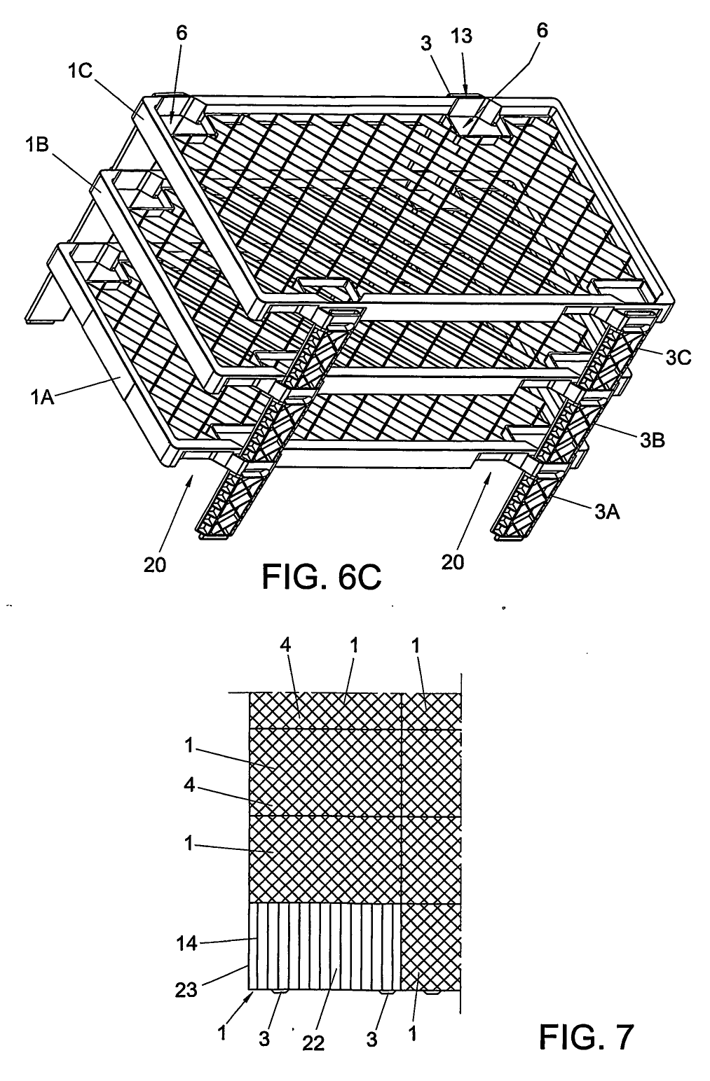

FIGS. 6A-C show a carrier according to FIG. 1 in stacked condition, in a number of views; and

FIG. 7 shows a number of carriers according to the invention, in juxtaposed condition, with a growing tray, by way of illustration.

In this description, the same or corresponding parts have the same or corresponding reference numerals. Herein, merely exemplary embodiments are represented which should not be construed as limiting in any way. In the exemplary embodiments shown, a plastic carrier is shown, which is manufactured by injection molding. Thus, a relatively cheap, light, strong carrier is obtained. However, such a carrier can also be manufactured in a different manner and from different materials, for instance from metal, wood or the like. In the exemplary embodiments shown, the carrier is designed in one piece. It will be clear, however, that it could also be composed of different parts.

FIG. 1 shows in bottom view a carrier 1 according to the invention, which is represented in perspective bottom view in FIG. 4. FIGS. 2 and 3 respectively give a side and front view of the carrier 1. A carrier 1 according to the invention comprises a supporting surface 2, carried by a number of legs 3. The supporting surface 2 has a substantially rectangular outer contour 4 of a length L and a width B. In the embodiment shown, four legs 3 are provided, on each long side 5 of the supporting surface 2. As is clearly visible in the bottom view of FIG. 1 and the side view of FIG. 2, the legs on the first long side 5A are staggered relative to the legs 3 on the opposite long side 5B over a distance X, which is at least equal to and preferably slightly greater than the width P of each leg, such that in side view according to FIG. 2, the legs 3 are visible next to each other.

As appears clearly from FIG. 1, next to each leg 3 an opening 6 is provided, of which a detail is shown in FIG. 1A. Each leg 3 extends at least substantially and preferably entirely outside the outer contour 4 of the supporting surface 2, while each opening 6 extends virtually entirely and preferably completely within the outer contour 4. The outer contour 4 is determined by a slightly upstanding edge 7, which imparts additional strength and moreover prevents a tray which, as will be elucidated hereinafter, can be placed on the supporting surface 2, from shifting relative thereto.

Each opening 6 has a width P1, measured in the longitudinal direction L, which is at least greater than the width P of each leg P, and a width P2, measured in the width B of the supporting surface 2, which at least corresponds to the thickness D of the leg 3, measured in the width B of the supporting surface 2. In the embodiment shown in FIG. 1, the width P2 approximately equals four times the thickness D of a leg 3, for reasons to be further mentioned hereinafter. As appears clearly from FIG. 1A, each leg 3 in top plan view is slightly trapezoidal, while the part of the opening 6 extending in the edge 7 has the same trapezoidal shape. Thus, a strong connection between the leg 3 and the supporting surface 2, at least the edge 7, is preserved, while a leg 3 of a carrier to be nested can be received in this trapezoidal part of the opening 6 with a proper fit. The supporting surface 2 within the edge 7 is substantially built up by a grid 8 of ribs 9, so that a light, stiff construction is obtained, through which much air and water can pass. The legs 3 are provided on the outside with comparable stiffening ribs 10 and preferably have a closed end face 11, although this can also be an open construction. At the lower end, each leg 3 is provided with a downwardly extending lip 12, which lip 12 can be received in a recess 13 in the top of a leg 3 of another tray, such that a form closure is obtained, as will be further elucidated with reference to FIG. 6.

FIGS. 5A-D show a number of views of four carriers 1 according to the invention, in a nested storage position. The four carriers are designated as carriers 1A-1D, the parts of the respective carriers being designated with the same indices A-D. As appears clearly from FIG. 5A, a top plan view of four nested carriers, the carriers 1A-1D have in each case been inserted by two legs 3 on a long side, through the opening 6 next to a leg 3 of a lower carrier. As a result of the chosen dimensions, in the embodiment shown, four carriers 1A-1D can be nested in this condition, as schematically represented in perspective view in FIG. 5D and in American projection in FIGS. 5A-C. Naturally, through a different choice of the dimensions of specifically the openings 6 and the thickness of the legs 3, it can also be arranged for a different number of carriers to be nested in this condition. As appears from the figures, in this way a particularly compact stacking is obtained.

In FIG. 5B, in broken lines, a fifth carrier 2A′ is shown, which is supported by the legs 3A′ on the legs 3A of the bottommost carrier of the first series. The lip 12 of the respective carrier 2A′ reaches into the opening 13 of the bottommost carrier 2A. Accordingly, in this way, a second series can be built up-on top of the first series shown in FIG. 5. In this way, a particularly large number of carriers can be stacked, in a compact, stable nested position.

FIG. 5C shows, in broken lines, a tray 14, supported on the ribs 9 of the framework 8, with an outwardly reaching edge 15 of the tray being disposed at some distance from the upper side of the edge 7. As a result, air can flow between the carrier 1 and the tray 14. The tray 14 is preferably manufactured through vacuum forming from plastic and has rows and columns of growing cavities. Such trays are sufficiently known as such and are used as growing trays.

FIGS. 6A-C show three views of a series of carriers 1 according to the invention, in this case three. Again, the different parts of the carriers are indicated by the same indices A-C. FIG. 6A shows in top plan view an upper carrier 1C having under it (not visible) two further carriers 1B and 1A. FIG. 6C shows this stacked position in perspective view. As appears from FIGS. 6A-C, the lips 12 of the upper carriers 1B and 1C can be inserted into the openings 13 of the subjacently arranged carriers 1A and 1B, respectively, so that shifting of the carriers 1 relative to each other is effectively prevented and the carriers 1A-1C can be simply picked up jointly. As a result of this stacking, between the underside 17 of the supporting surface 2 of each upper carrier 1 and the upper side 18 of each supporting surface 2 of the lower carrier 1, a distance K is obtained, approximately corresponding to the height of the leg 3, so that space is obtained for a tray 14 with crop 19, such as, for instance, seedlings, small plants 19 and the like.

In the longitudinal edge 7 of the supporting surface 2 of each carrier 1, next to each leg 13, in the longitudinal edge 7, a recess 20 is provided, in side view coinciding with the upper end of a leg 3 on the opposite long side 5 of the respective carrier 1. This recess has a contour 21 approximately corresponding to the earlier-described trapezoidal outer shape of the leg 3 and is preferably closed at the top by an edge part 7A of the edge 7. Each leg 3 terminates at a small distance D from the upper side of the edge 7, seen in side view, so that when two carriers 1 are moved against each other by their longitudinal edges 5A, 5B, the legs 3 of the first carrier 1 can be received in the recesses 20 of the carrier 1 moved against it, and vice versa, so that the outer contours 4 of the respective carriers 1 are in mutual abutment. In FIG. 6 this is schematically represented by broken lines. As a result, in an optimum manner, use can be made of available growing surface.

FIG. 7 schematically shows a top plan view of rows and columns of carriers 1, with a growing tray 14 with growing cavities 22 being shown on the carrier 1 shown at the bottom, left, in FIG. 7. In this embodiment, substantially rectangular growing cavities 22 are represented, set up in a matrix of rows and columns. The outer contour 23 of this tray 14 is substantially equal to the outer contour 4 of the carrier 1, so that the same trays 14 can be placed on the other carriers 1, with the outer contours 4 of the carrier 1 touching each other. Clearly, optimum utilization of growing surfaces has thus been obtained.

With an assembly of a series of carriers 1 according to the invention and a series of growing trays 14 according to the invention, cultivation can be realized in a particularly advantageous manner. Carriers 1 are supplied in nested condition, so that minimal transport volume is required. Next, the carriers 1 are set up on a growing surface, on the legs 3, and moved against each other to form rows and/or columns as shown in FIG. 7. Trays 14 can then be placed on the supporting surfaces 2. Naturally, these can also be placed first. In the growing trays 14, crop can then be grown. If the trays 14 are to be manipulated, for instance for transport, storage and the like, carriers 1 can be stacked, in the condition shown in FIG. 6, so that they can be moved in groups. This does not entail damage to the crop 19. After use, the trays 14 can be removed and the carriers, optionally after cleaning, can be stored for reuse in the nested position in FIG. 5.

The invention is not limited in any way to the exemplary embodiments represented in the description and drawing. Many variations thereon are possible within the framework of the invention outlined by the claims.

Thus, as indicated earlier, different materials can be used, also in combination. Further, different numbers of legs can be provided, in different positions. Positioning legs adjacent corners has the advantage of yielding a stability. A supporting surface can also be designed in a different manner, for instance entirely closed, flat or profiled. The dimensions of the openings 6 and the legs 3 can also be chosen differently, such that, for instance, different numbers of carriers can be stacked. Also, a supporting surface can have a different main shape, for instance octangular.

These and many comparable variations are understood to fall within the framework of the invention outlined by the claims.

1. A carrier for growing trays, comprising a series of legs and a supporting surface carried thereby, wherein:
in said supporting surface, adjacent at least one of the legs, an opening is provided, such that the carriers in a storage position are stackable in nested position, with a number of legs of one or more upper carriers reaching into at least a number of said openings of a lower carrier; and
the supporting surface determines at least one outer contour, while the legs extend at least partly outside said outer contour, such that two carriers in a position of use are stackable, with the legs of an upper carrier resting on the legs of a lower carrier.

2. A carrier according to claim 1, wherein the carrier is designed such that next to at least one of the legs, a recess is provided, partly situated within said outer contour viewed at right angles to the supporting surface, the arrangement being such that two carriers can be arranged next to each other, with at least two legs of a first carrier being received at least partly in a recess of a second carrier arranged next to it, and vice versa.

3. A carrier according to claim 1, wherein the outer contour is determined by a longitudinal edge which is raised relative to the supporting surface.

4. A carrier according to claim 1, wherein on at least two opposite sides of the supporting surface, at least two legs are provided, wherein, seen in side view, the legs on a first side of the supporting surface are staggered relative the legs on the opposite side, such that the legs on the first and opposite sides, in said side view, are visible at least substantially next to each other.

5. A carrier according to claim 1, wherein each opening has dimensions such that therein at least two legs can be received next to each other.

6. A carrier according to claim 1, wherein the supporting surface is manufactured in a form of a grid.

7. A carrier according to claim 1 wherein
a set of such carrier, when stacked in a storage position, are stackable in a nested arrangement, with the legs of at least one carrier resting on the legs of a lower carrier, thereby enclosing at least one supporting surfaces of intermediate carriers; and
when in a position of use, a set of the carriers are placeable next to each other, for forming substantially continuous rows of carriers.

8. An assembly comprising:
a carrier for growing trays, comprising a series of legs and a supporting surface carried thereby, wherein:
in said supporting surface, adjacent at least one of the legs, an opening is provided, such that the carriers in a storage position are stackable in nested position, with a number of legs of one or more upper carriers reaching into at least a number of said openings of a lower carrier, and
the supporting surface determines at least one outer contour, while the legs extend at least partly outside said outer contour, such that two carriers in a position of use are stackable, with the legs of an upper carrier resting on the legs of a lower carrier; and
at least one tray with plant cavities, carried by the supporting surface of the carrier, and wherein the at least one tray has an outer contour substantially corresponding to the outer contour of the supporting surface.

9. An assembly according to claim 8, wherein the tray is provided with a collar substantially determining the outer contour, which, in the condition when placed on the carrier, is spaced from the respective supporting surface.

10. An assembly according to claim 8, wherein in said position of use a series of carriers are placeable next to and/or behind each other, such that trays supported thereon substantially abut each other.

11. An assembly according to claim 10, wherein in said position of use, the supporting surfaces and/or legs of the respective carriers substantially abut each other.

12. (canceled)

13. A method for growing and transporting seedlings and the like, using assemblies comprising:
a carrier for growing trays, comprising a series of legs and a supporting surface carried thereby, wherein:
in said supporting surface, adjacent at least one of the legs, an opening is provided, such that the carriers in a storage position are stackable in nested position, with a number of legs of one or more upper carriers reaching into at least a number of said openings of a lower carrier, and
the supporting surface determines at least one outer contour, while the legs extend at least partly outside said outer contour such that two carriers in a position of use are stackable, with the legs of an upper carrier resting on the legs of a lower carrier; and
at least one tray with plant cavities, carried by the supporting surface of the carrier, and wherein the at least one tray has an outer contour substantially corresponding to the outer contour of the supporting surface, and wherein the method comprises the steps of:
supplying a series of the assemblies to an environment of use, with the carriers being nested;
arranging the carriers next to and/or behind each other at a growing position and the trays are placed on supporting surfaces thereof, such that the trays substantially abut each other without intermediate space;
placing seedlings in the plant cavities for growing therein;
stacking the carriers, with trays supported thereon having seedlings growing therein, positioning the legs of a first carrier on the legs of a lower, second carrier;
conveying the stacked carriers with trays and seedlings to a planting position;
repotting the seedlings in the planting position;
removing the trays and stacking the carriers in said nested position and returning the carriers to said position of use.

14. An assembly according to claim 8 wherein the carriers are substantially manufactured by injection molding and the trays are substantially manufactured through deformation of sheet material.

15. An assembly according to claim 14 wherein the trays are manufactured through a vacuum forming technique.

16. A carrier according to claim 1 wherein an opening is provided in said supporting surface adjacent each of the legs.

17. A carrier according to claim 2 wherein the carrier is designed such that the recess is provided next to each of the legs.

18. A carrier according to claim 7 wherein the legs of at least one carrier rest on the legs of a lower carrier thereby enclosing at least two supporting surfaces of intermediate carriers.

19. An assembly according to claim 8 wherein an opening is provided in said supporting surface adjacent each of the legs.
